(19) United States
(12) Patent Application Publication
(10) Pub. No.: US 2016/0092653 A1
(43) Pub. Date: Mar. 31, 2016

(54) NUTRITIONAL INTAKE VIEWER (NutriWeb)

(71) Applicant: KONINKLIJKE PHILIPS N.V., EINDHOVEN (NL)

(72) Inventor: Maria F. HENDRICKSON, Chelmsford, MA (US)

(21) Appl. No.: 14/849,886

(22) Filed: Sep. 10, 2015

Related U.S. Application Data
(60) Provisional application No. 62/057,282, filed on Sep. 30, 2014.

(51) Int. Cl. G06F 19/00; G06T 11/20; G09B 19/00

(52) U.S. Cl. CPC G06F 19/3475; G09B 19/0092; G06T 11/206; G06T 11/203; G06T 2210/41

(57) ABSTRACT

A nutritional intake viewing apparatus monitors patient nutrient intake. One or more processors receives nutrient input information, generates one or more multi-axis web diagrams on the display, and graphs calculated nutrient amounts onto a corresponding one of the axes. Each multi-web diagram includes a plurality of axes diverging from a single common point of intersection, calculated nutrient amounts displayed on the axes, and connecting lines that connect the calculated nutrient amounts on the axes to form a polygon of the calculated nutrient amounts.

### CROSS REFERENCE TO RELATED APPLICATIONS

This application claims the benefit of U.S. provisional application Ser. No. 62/057,282 filed Sep. 30, 2014, which is incorporated herein by reference.

The present application relates generally to patient care systems for presenting information to facilitate speed and accuracy of patient medical information. It finds particular application in conjunction with nursing and physician care of neonatal patients and in neonatal intensive care units. However, it is to be appreciated that it will also find application with respect to other patient populations and in other usage scenarios, and is not necessarily limited to the aforementioned application.

There exists various tools to calculate the amount of nutrients in food. An individual may enter the food and the amount, and the tool can calculate the amount of nutrients the individual has received. Other tools exist in which a physician may enter a particular nutrient therapy, and the tool reports the amount of nutrients that will be administered within a particular time period. Some of these tools will inform the user how their nutritional intake compares to their goal. For example, a food intake calculator may report that an individual has consumed 800 calories based on the food and amount of food they have entered, and that they have 400 calories left for a day with a goal of 1200 calories a day.

In a clinical care unit, such as a neonatal intensive care unit, nutrition is extremely important. Like adults, intake of calories, fat, protein, sodium, and starch is important. However, in neonates, electrolytes and micronutrients are also extremely important. Moreover, neonates often receive a plurality (e.g., 3, 4, 5, or more) formulas or nutrient therapies at a time, each having a different blend of nutrients, electrolytes, and micronutrients.

A physician caring for a neonate typically writes orders for the patient's nutrient intake on a daily basis. These orders may include enteral feedings of formula, breast milk, and other nutrients that are to be ingested. Orders may also include nutrients taken intravenously, such as total parenteral nutrition (TPN). These orders take effect daily at an anchor time, which is usually a hospital-approved time of day at which all new neonatal intensive care unit (“NICU”) nutrient orders take effect. In other words, an anchor time is a care unit standard that denotes the beginning and end of each 24 hour period.

Each day, a physician must first determine how much of the nutrient and fluid a patient received in the last 24 hours. This involves the physician reviewing the patient's chart for charted administrations, such as enteral feeding intake orders, intravenous intake orders, bottle feedings, and other drugs. Nurses report frequently how much is given for all of these administrations in the patient's chart. Because patients such as neonates often receive a plurality of nutrient and drug therapies, the physician may have to review the charting of hundreds of administrations. The physician then determines the amount of nutrients in each intake order, and using a calculator or scratch pad, totals the patient's nutrient intakes. Then, the physician compares those totals to industry standards. However, because industry standard nutritional intake goals are weight based (e.g., the number of calories per kilogram of patient's weight), the physician looks-up the patient's weight, which is recorded in another part of the patient's chart, and divides each nutrient intake total by the patient's weight. Additionally, the physician reviews the intake and output fluid totals to determine whether the patient is receiving too many fluids. Finally, depending on how the patient's nutrient intake totals compared with industry standards, the physician then calculates and writes new intake orders to be administered over the next 24 hour period. If medical conditions change, then calculations can be repeated and revised intake orders written for the remainder of the day.

Because reviewing the patient's chart, knowing the nutrient composition of intake materials, and calculating nutrient-specific intake based on intake orders is tedious and time consuming, physicians are limited to focusing on the main nutrients, such as calories, carbohydrates, protein, and fats. Thus, one major gap of the current system is that many of the electrolytes and micronutrients are not closely and accurately monitored. Moreover, there is currently no easy way to compare the intake totals across multiple time periods (e.g., for yesterday, today, and tomorrow). In other words, physicians are limited in their ability to effectively and efficiently compare a patient's nutritional intake trends, and prospectively write new intake orders that will address all of the patient's evolving nutritional needs. Additionally, the risk for mathematical error is high given the number of calculations that are required. Thus, monitoring nutritional intake of patients, especially NICU patients, is extremely difficult and error prone.

Given the current limitations facing physicians and the importance of monitoring not only general nutrient intake but also the intake of electrolytes and micronutrients for particular patient populations such as neonates, there is a need for quicker and easier access to a patient's nutritional intake information. There is a need in particular patient populations for a tool that allows physicians to view retrospective and prospective nutritional intake information that is readily available and consistently displayed. Moreover, there is a need in particular patient populations for a tool that allows physicians to compare this retrospective and prospective nutritional intake information based on a per-patient-weight basis in order to readily compare with industry standards, particularly in a more intuitive manner. Finally, there is a need in particular patient populations for a tool that allows physicians to readily address a patient's nutritional intake needs across a plurality of therapies (i.e. patients receiving a plurality of formulas or nutrient therapies or drug therapies).

The present application provides new and improved apparatuses and methods, which overcome the above-referenced problems and others.

The present application proposes to use a nutritional intake web with specified spokes assigned to specific nutrients to readily display general nutrients, electrolytes, and micronutrients. The use of easy to access and easy to read patient nutrient intake information improves clinical productivity and patient care, and facilitates physician review to determine if nutrient intakes are below, meeting, or exceeding nutritional goals.

In accordance with one aspect, a nutritional intake viewing apparatus is used for monitoring patient nutrient intake. It includes a workstation including a display device configured to display nutritional and physiological information and an input configured to receive one or more inputs. One or more processors are connection with the workstation and are configured to receive nutrient input information, generate one or more multi-axis web diagrams, each axis corresponding to one of a plurality of nutrients, and graph calculated nutrient amounts onto a corresponding one of the axes. The processor is further configured to update the display based on inputs or additional nutritional input information received at the workstation.

In accordance with one aspect, a multi-dimensional web diagram which displays a patient's nutritional intake information is provided. The multi-axis web diagram includes a plurality of axes, each axis corresponding to one of a plurality of calculated nutrient amounts. The calculated nutrient amounts are graphed onto a corresponding one of the axes.

In accordance with one aspect, a method of monitoring nutritional intake of a patient is provided. Nutrient input information is received at a workstation. With one or more processors, one or more multi-axis web diagrams are generated on a display, each axis corresponding to one of a plurality of nutrients, and graphing calculated nutrient amounts onto a corresponding one of the axes. The display is updated based on input information or additional nutrient input information received.

One advantage resides in improve readability of patient nutritional intake information, including the more intuitive layout and display of patient information.

Another advantage resides in improved availability of the patient nutritional intake information.

Another advantage resides in improved clinical workflow and clinical productivity.

Another advantage resides in improved patient care.

Still further advantages of the present invention will be appreciated to those of ordinary skill in the art upon reading and understanding the following detailed description.

The invention may take form in various components and arrangements of components, and in various steps and arrangement of steps. The drawings are only for purposes of illustrating the preferred embodiments and are not to be construed as limiting the invention.

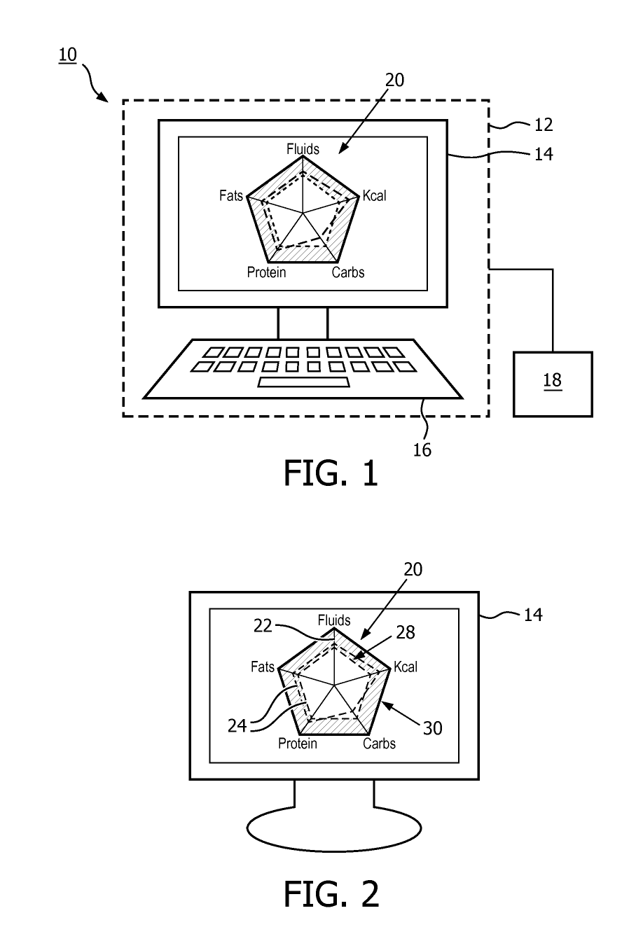

FIG. 1 illustrates a nutritional intake viewing apparatus according to one embodiment.

FIG. 2 illustrates a display of a nutritional intake viewing apparatus according to one embodiment.

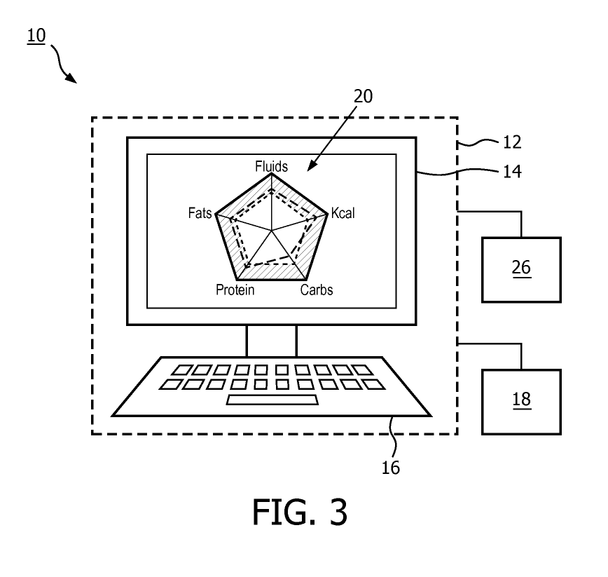

FIG. 3 illustrates a nutritional intake viewing apparatus according to a second embodiment.

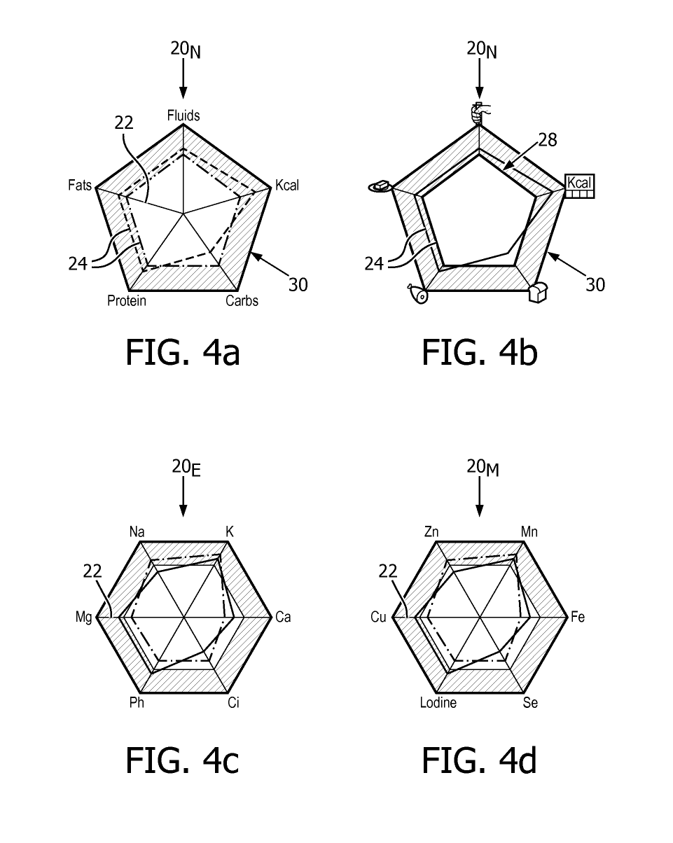

FIG. 4a diagrammatically displays a patient's nutritional intake information using a multi-axis web diagram using a general nutritional web diagram according to one embodiment.

FIG. 4b diagrammatically displays a patient's nutritional intake information using a multi-axis web diagram, specifically a general nutritional web diagram according to another embodiment.

FIG. 4c diagrammatically displays a patient's nutritional intake information using a multi-axis web diagram, specifically an electrolytes web diagram according to another embodiment.

FIG. 4d diagrammatically displays a patient's nutritional intake information using a multi-axis web diagram, specifically a micronutrients web diagram according to another embodiment.

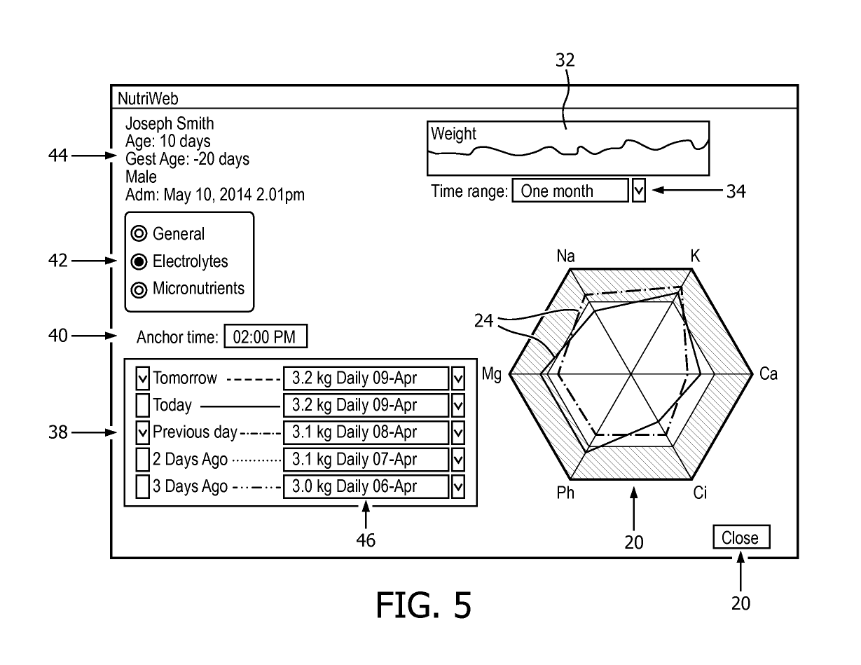

FIG. 5 diagrammatically displays a multi-axis web diagram, specifically an electrolytes web diagram, as one element to be displayed on a display according to an embodiment.

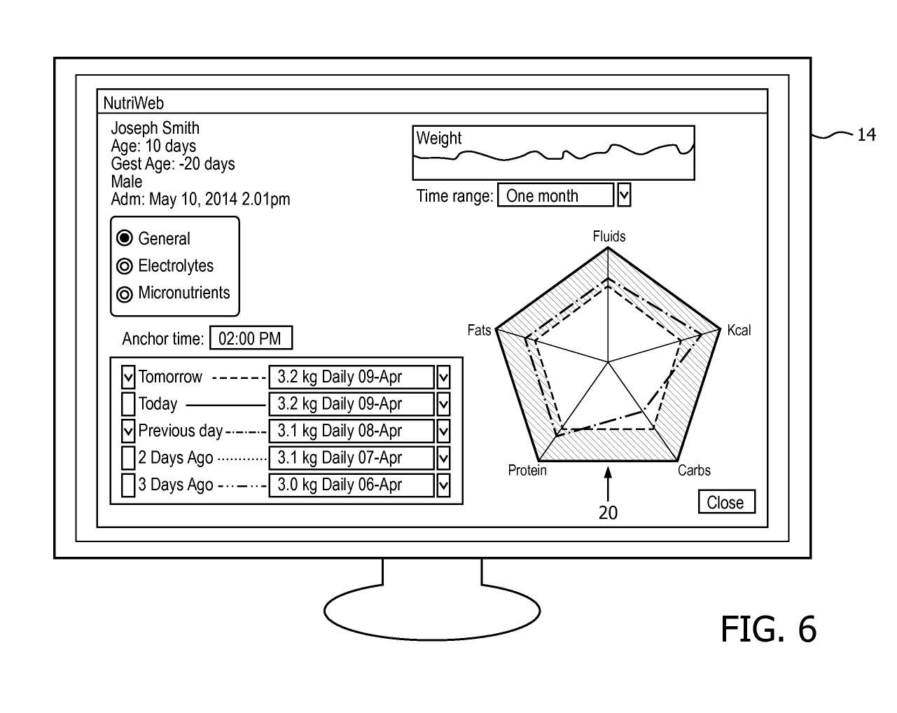

FIG. 6 illustrates a display of a nutritional intake viewing apparatus including a multi-axis web diagram as one element being displayed.

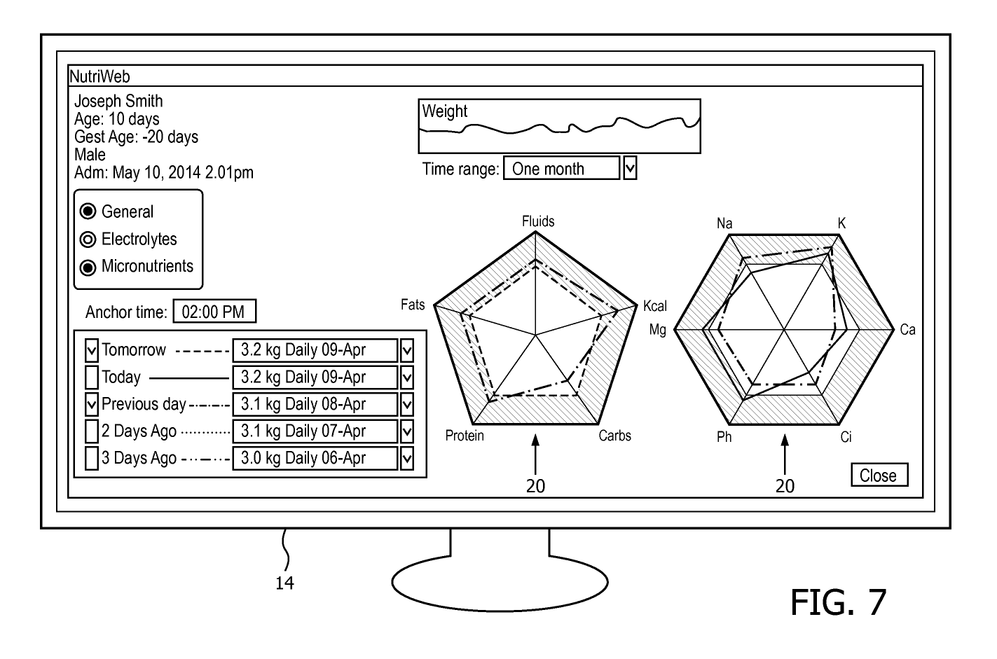

FIG. 7 illustrates a display of a nutritional intake viewing apparatus including multiple multi-axis web diagrams as elements being displayed.

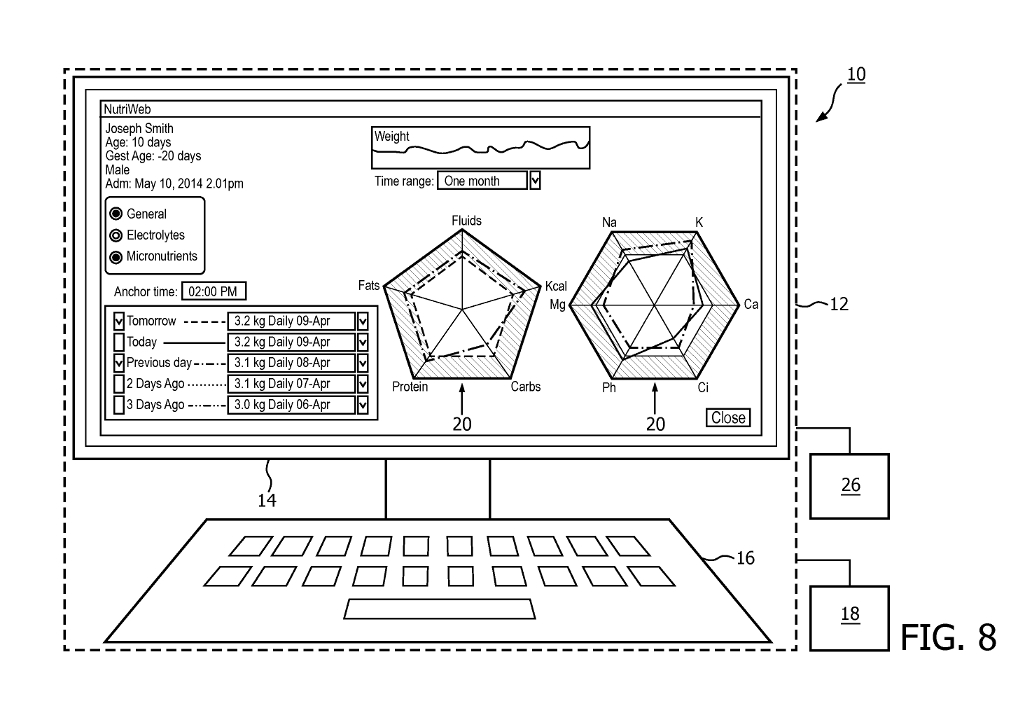

FIG. 8 illustrates a nutritional intake viewing apparatus according to an embodiment of the present invention including multiple multi-axis web diagrams as elements to be displayed on a display.

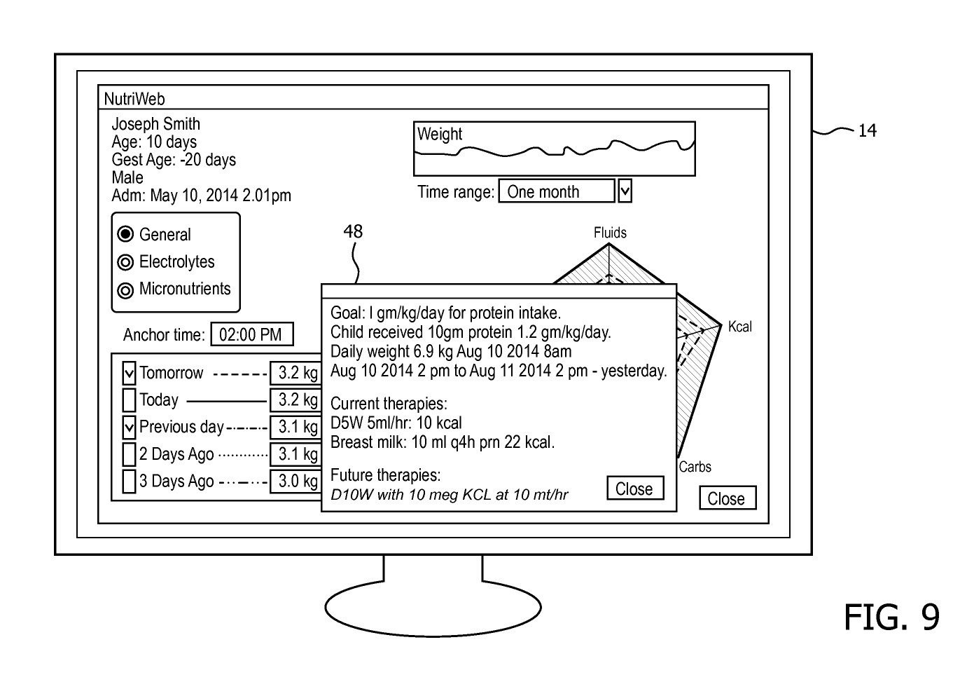

FIG. 9 illustrates a display of a nutritional intake viewing apparatus including a detailed information dialog as an element of a display according to one embodiment.

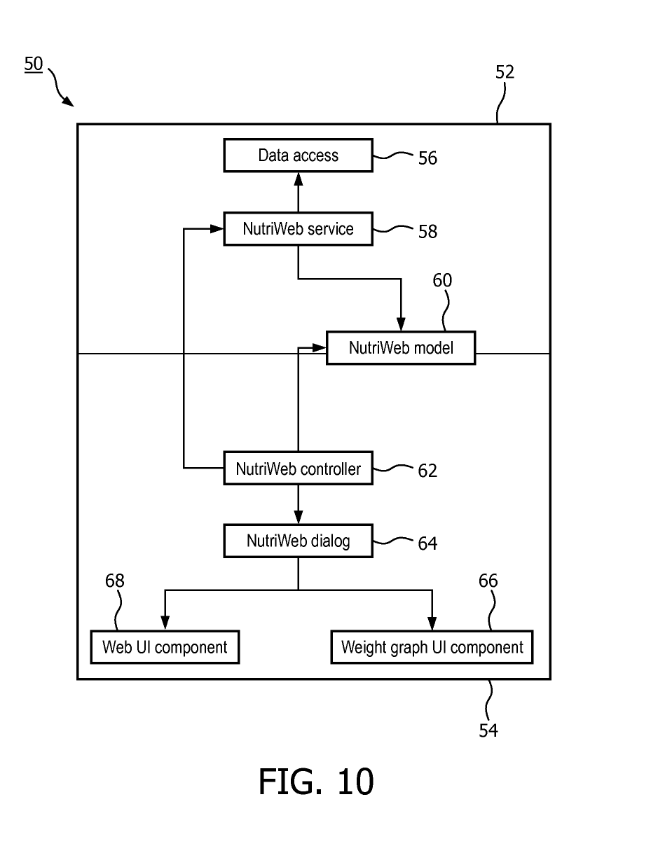

FIG. 10 illustrates a method flow chart or means diagram for monitoring the nutritional intake of patients by using a nutritional intake viewing apparatus.

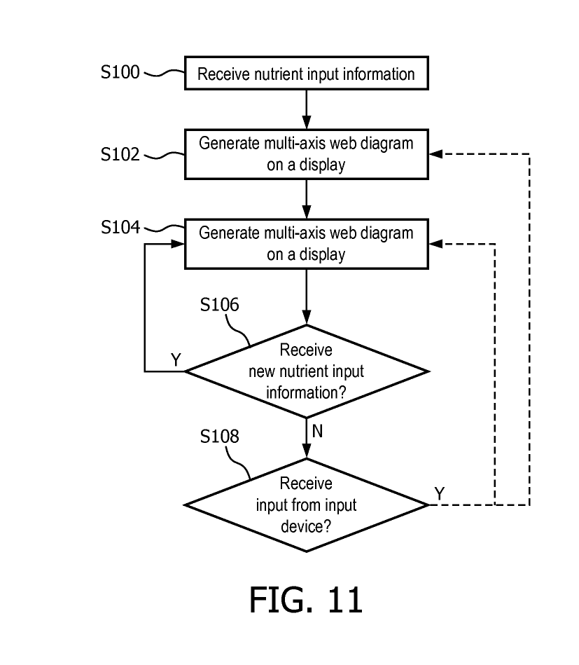

FIG. 11 illustrates a block diagram of a system infrastructure of a medical institution according to aspects of the present application.

The present application is directed to apparatuses and methods for displaying a patient's nutritional intake information on a display. The present application is also directed to methods of evaluating a patient's nutritional intake information.

The present application is further directed to apparatuses and methods incorporating and displaying the patient's nutritional intake information in a consistent and readable display format.

The present application is further directed to apparatuses and methods incorporating and displaying both retrospective and prospective nutritional intake information for a patient.

The present disclosure is inspired by the insight that current methods and tools for reviewing patient nutritional information are tedious, error prone, time-consuming, and do not address all of the nutrients vital for particular patient populations, such as neonates. Thus, current methods and tools may not be appropriate for particular patient populations and/or result in slower data interpretation and decreased accuracy of data interpretation by clinicians. Currently, tools exist such as online nutrition calculators and nutrient therapy reporters. However, these tools do not involve the use of a nutrition web in which patient nutrition is measured against industry standards and calculated based on the patient's weight. The use of the proposed tools and methods for patient nutritional intake information will allow faster data interpretation and improved patient care.

FIG. 1 illustrates a nutritional intake viewing apparatus 10 for monitoring patient nutrient intake. According to this embodiment, the apparatus 10 includes a workstation 12 and one or more processors 18 connected to the workstation 12. The workstation includes a display 14 configured to display nutritional and physiological patient information and an input device 16 configured to receive inputs from the user, databases, or other sources of information. The one or more processors 18 connected to the workstation 12 are configured to: receive nutrient input information; generate one or more multi-axis web (“MAW”) diagrams 20 on the display 14; graph 24 calculated nutrient amounts on a MAW diagram; and update the display 14 based on input from the input device 16 or in response to receiving additional nutrient input information.

As seen in FIG. 2, the one or more processors 18 of the apparatus 10 are configured to generate one or more MAW diagrams 20 on a display 14, wherein each axis 22 corresponds to one of a plurality of nutrients. The one or more processors 18 are configured to graph 24 calculated nutrient amounts onto a corresponding one of the axes. 22 Multiple graphs 24 of calculated nutrient amounts may be plotted onto the corresponding axes 22. Additionally, in particular embodiments, the MAW diagram 20 may include an inner polygon 28 and an outer polygon 30, each bordering a region defining a target range of nutrient values.

Additionally, as seen in FIG. 3, in some embodiments, the workstation 12 of the apparatus 10 can be connected to at least one memory systems 26 in which patient information, including nutritional information, is stored. The memory 26 can also store calculated nutrient amounts for a plurality of prior days, and additional input information may be stored, such as the nutritional composition of therapies to be administered to a patient. In some embodiments, the memory 26 includes a clinical information system, which may support the ordering of nutrient intakes and the charting of administrations. In particular embodiments, the memory 26 may be a Philips Intellivue Critical Care and Anesthesia™ (ICCA) system, which includes a database that contains detailed formulations for the various intake materials and which can be updated to add more. In a NICU, the therapies often include a variety of formulas. Often, a patient is given a combination of formulas. The memory can store the composition of each formula.

FIGS. 4a through 4d diagrammatically display a patient's nutritional intake information using one or more multi-axis web diagrams 20. The layouts in FIGS. 4a-4d include the MAW diagram 20, which include a plurality of axes 22 radiating from a single common point of intersection and extending away towards an outer polygon 30. The MAW diagrams 20 typically include a plurality of axes 22 with generally equally angular regions between them. The axes 22 correspond to specific nutrients or physiological measurements. Patient information is displayed on each of the axes 22 and connected by connecting lines to graph 24 calculated nutrient amounts onto the corresponding axes 22. In particular embodiments, a plurality of graphs 24 can be generated simultaneously on a single MAW diagram 20. In particular embodiments, each graph 24 corresponds to calculated nutrient amounts for a single patient from the same period of time. The one or more processors 18 are configured to receive amounts of each formula or therapy, retrieve the compositions of the formulas or therapies from the memory, and calculate the amount of each ingredient that the patient has or is scheduled to receive. The calculated nutrient amounts can be normalized by patient weight, such as 1 gram of protein per kilogram of patient weight. The one or more processors receives an input from an electronic scale indicative of patient weight and divides the calculated nutrient amounts by the weight. The graphs 24 can be based upon patient information stored in a memory 26 system, and can incorporate information that is in the patient's chart and can includes therapies that have been prescribed but have yet to be administered. In other words, the graphs 24 may prospectively graph 24 calculated nutrient amounts stored in the memory 26 based upon stored intake orders, unstored intake orders (i.e., intake orders that have been entered by a physician but have not been signed-off on), orders that are currently being administered, and intake administered in the past.

In particular embodiments, the inner 28 and outer 30 polygons border regions that define nutrient intake values within target ranges of values. In particular embodiments, the inner polygon 28 defines a region of abnormal intake values, while the region between the inner polygon 28 and outer polygon 30 defines a region of normal or above expected values. When prescribing formulas or therapies, the clinician can view a proposed prescription. If the graphs 24 are not satisfactory, the clinician can try adjusting the formulas in the proposed prescription until the graphs provide a satisfactory amount of each ingredient, e.g., lie completely between the inner and outer polygons. In another embodiment, the one or more processors can propose prescriptions to the clinician.

FIG. 4a illustrates a general nutritional web diagram 20_{N} according to one embodiment. In particular embodiments, the general nutrients displayed on a general nutritional web diagram 20_{N} can include fluids, fats, protein, carbohydrates, and calories. Other nutrients are also contemplated. The embodiment shown in FIG. 4a illustrates a diagram 20 with five axes 22 corresponding to five nutrients. By displaying the general nutrients on the general nutritional web diagram 20_{N}, a clinician no longer has to review each patient's chart and add up all of the charted administrations from a plurality of therapies to determine how much of each nutrient that patient received in a given time period. By using the apparatus 10, the clinician can easily see whether the calculated total amounts of each nutrient are reaching their goal. In other words, the clinician can easily determine whether the graphs 24 of the calculated nutrient amounts fall within the abnormal region bordered by the inner polygon 28 or the normal region between the inner polygon 28 and the outer polygon 30. For example, in the embodiment shown in FIG. 4a, a clinician viewing the nutritional web diagram on the apparatus 10 could easily determine that the calculated nutrient amounts for fats and fluids is balanced at that inner polygon 28, indicating that these nutrients are meeting the goals for the patient based on the patient's weight. However, whether a calculated nutrient intake level is normal or abnormal can depend on the particular nutrient. For example, a fluid level between the inner polygon 28 and the outer polygon 30 can indicate an abnormal amount, since a high fluid amount is a negative condition, whereas another nutrient within the same region may indicate a normal condition. Thus, in particular embodiments, some of the calculated nutrient amounts may be in reverse orientation than the orientation of the other nutrients.

FIG. 4b illustrates a color-coded general nutritional web diagram 20_{N} according to another embodiment. In particular embodiments, the connecting lines that connect the calculated nutrient amounts on the axes 22 of the web diagram are color-coded. The graphs 24 or connecting line can be coded by color, line type, or the like, to indicate intake on different days, e.g., yesterday and today, or scheduled to be administered tomorrow. In particular embodiments, the regions defined by the inner polygon 28 and the outer polygon 30 may also be color or otherwise visually coded.

FIG. 4c illustrates an electrolytes web diagram 20_{E}. In one embodiment, the electrolytes web diagram 20_{E} includes axes 22 corresponding to electrolytes such as sodium, potassium, calcium, chloride, phosphate, and magnesium. Optionally, fewer or additional electrolytes are displayed. The embodiment shown in FIG. 4c displays six electrolytes corresponding to six axes 22.

FIG. 4d illustrates a micronutrients web diagram 20_{M}. In one embodiment, the micronutrients web diagram 20_{M} can include axes 22 corresponding to micronutrients such as zinc, manganese, iron, selenium, iodine, and copper. Optionally, fewer or additional micronutrients can be displayed as in medically appropriate.

FIG. 5 diagrammatically displays the electrolytes web diagram 20_{E} as an element to be displayed on the display 14 of the workstation 12. The layout may include: a weight graph 32 that displays the weight trend of a patient over a time range 34, e.g., one month; one of the MAW diagrams 20; a close button 36, e.g., a region of a touch screen, close the nutritional intake display; a time range selector 38 to control which graphs 24 of the calculated nutrient amounts are displayed, e.g., today's, today and yesterday, etc.; an anchor time display 40 which displays the time which defines the beginning of each day; a web toggle 42 by which the clinician sets the general nutritional web diagram 20_{N}, the electrolytes web diagram 20_{E}, and the micronutrients web diagram 20_{M}, and a patient identification area 44 that displays to the user key information about the patient.

An anchor time 40 is predetermined time selected as a hospital, institution, or clinical care unit standard. The anchor time 40 denotes the beginning and end of each 24 hour period used for measuring and charting patients. The anchor time 40 also indicates the time at which all new intake orders are supposed to take effect. The anchor time 40 can be any time, and can vary among hospitals or care units. In the embodiment shown, the anchor time is 2:00 pm. Thus, for example, the fluids received between 2:01 pm yesterday and 11:59 pm today can be considered today's intake, and the 24 hours before 2:00 pm yesterday are considered the previous day's intake.

The time range selector 38 allows a clinician to view multiple calculated nutrient amount graphs 24 concurrently. The selector 38 can be a processor configured to allow a user to select retrospective, current, and prospective nutritional information. In the embodiment shown, the time range selector 38 is configured to allow a user to optionally graph 24 calculated nutrient amounts for five 24-hour periods based on the anchor time 40 of 2:00 pm. In other embodiments, the number of time periods may vary. Additionally, in embodiments wherein the graphs 24 are color-coded, such as in FIG. 4b, the time ranges in the selector 38 can be color-coded to correspond with the color of the displayed graphs 24. In this manner, clinicians using the apparatus 10 and viewing the display 14 of a MAW diagram 20 can readily identify and distinguish trends in nutritional intake information across several time periods by visually comparing the graphs. In the embodiment shown, two time periods are selected, resulting in two graphs 24 being displayed. Optionally, a drop-down menu 46 is provided for each time range toggle that can be selected. This menu 46 can display all of the weights applicable to that patient for the corresponding time range. The weight displayed depends on the time period. For example, the menu 46 corresponding to the “3 Days Ago” toggle only includes the weights that were charted prior to the anchor time 40 three days ago. In the embodiment shown, all of the weights displayed in the menus 46 are daily weights. However, a patient may have different categories of weight measurements, such as daily weight, admission weight, weekly weight, and post-operative weight. In some embodiments, there is only one weight entry in the drop-down list 46 for some time range toggles, such as admission weight. The weight displayed is pre-selected upon initializing the display based upon the care unit's configured default weight category. However, when a different weight is selected from the menu 46, the corresponding nutrient amounts are recalculated and the graph 24 is updated.

Because patient weight and/or weight trend is an indicator of patient health, particularly with respect to the neonatal patient population, the weight graph 32 displays the weight trend of a patient over a time range 34. The time range 34 can be configured to allow a user to select different ranges on the weight graph 32. For example, the time range 34 can be a time range selected from a drop-down menu. In the embodiment shown, the time range 34 is one month. In other embodiments, the drop-down list 34 can allow a user to select a time range of one week, two weeks, two months, six months, or one year. The list 34 may also allow a user to display a patient's weight since that patient's admission. For example, the list 34 may include a “since admission” option. Additionally, the weight graph 32 may be configured such that hovering over a point on the graph will cause the weight value, its type, and its date and time to be displayed. For example, a clinician using the apparatus 10 can hover over a point on the weight graph 32 to learn that, at that point, the patient's weight was 3.1 kg, that the weight is a daily weight measurement, and that the measurement was taken on April 7.

A patient identification area 44 may also be prepared to be displayed on the display 14 of the apparatus 10. The patient identification area 44 can include information such as the patient's name, age, gestation age, gender, and admission date. The patient identification area 44 is configured by the hospital, care unit, or user, and may include fewer or additional information as appropriate.

FIG. 6 illustrates a display 14 of the nutritional intake viewing apparatus 10 including a multi-axis web diagram 20 as one element being displayed.

FIG. 7 illustrates a display 14 of a nutritional intake viewing apparatus 10 including multiple MAW diagrams 20 as elements being displayed. While in some embodiments, to conserve display resources, the clinician uses the web toggle 42 to display one MAW diagram 20 at one time, if there are adequate display resources, one, two, or more MAW diagrams 20 can be displayed concurrently, as illustrated.

FIG. 8 illustrates a nutritional intake viewing apparatus 10 according to an embodiment of the present invention including multiple MAW diagrams 20 as elements to be displayed on a display 14. The apparatus 10 includes a workstation 12 that is connected to one or more processors 18 and be connected to one or more memories 26. The workstation 12 includes a display device 14 and one or more input devices 16, such as a keyboard, a mouse, a touchscreen, or the like. The one or more processors 18 are configured to generate the one or more MAW diagrams 20 to be displayed on the display 14. The one or more processors 18 are also configured to look-up and retrieve input information from the one or more memories 26, as well as receive input from the input device 16. Input from the input device 16 can include toggling the time range selector 38, or the web toggle 42, and time range menu 34 on the touch screen. Input from the input device 16 can also include pushing the close button 36. Input from the memory 26 can include new and revised intake orders or therapies entered into the memory 26, either as a stored or unstored order, as well as additional administrations charted by the nurse. The one or more processors 18 are configured to update the display 14 based on input from the input device 16 and the memory 26. Additionally, input from the input device 16 can include clicking on a particular axis 22 of the MAW diagram 20.

As seen in FIG. 9, in particular embodiments, the one or more processors 18 can be configured to generate an additional dialog 48. This dialog 48 can include additional information specific to the nutrient corresponding to the axis 22 that was clicked, such as the nutrient's goal value or industry standard, calculated amounts of the nutrient, the specific time range that the nutritional intake graph 24 covers, a list of therapies that the patient received and how each therapy contributes to the calculated nutrient amount, a list of prospective therapies based upon orders in the chart and what nutrients are predicted to be given to the patient, as well as a list of therapies that are unstored orders.

FIG. 10 illustrates a block diagram of a system infrastructure 50 of a medical institution according to aspects of the present invention. In certain aspects the present invention relates to a nutritional intake viewing apparatus 10 that can be integrated into a clinical information system that supports the ordering of nutrient intakes and the charting of administrations. For example, the Philips Intellivue Critical Care and Anesthesia™ (ICCA) system is a clinical information system that supports the ordering of intakes and the charting of administrations, and can also support a nutritional intake viewing apparatus 10 according to the present application. This system includes the memory 26 that contains detailed formulations for the various intake materials and can be updated to add more.

In the illustrated embodiment, the system is a multi-tiered architecture based upon the Microsoft .NET framework and SQL server. The system infrastructure 50 includes a server tier 52 and a client tier 54. Both the server 52 and client 54 levels include one or more processors. The server tier 52 includes a data access module 56, a NutriWeb service module 58, and a NutriWeb model 60. The data access module can include a processor configured to retrieve patient data from a system database 26. The data access module 56 contains procedures to retrieve patient orders, administrations, and system configuration information. For example, the data access module 56 can access the memory 26 in order to retrieve nutrient intake orders written by clinicians, administrations charted by nurses, and configuration information such as the anchor time 40, default weight types, nutrient goals, the patient identification information, and the nutrient composition of intake materials. The NutriWeb service 58 can include a processor, and is configured to obtain the data sets from the database 26 for the nutritional intake viewing apparatus 10 using the data access module 56. The NutriWeb service 58 creates the NutriWeb model 60, e.g., one or more MAW diagrams 20, and initializes it with the information obtain from the data access module 56. The NutriWeb model 60 is created on the server 52, but is used on the client 54. The model can include a processor, and is configured to organize and sort all of the information needed for the display 14 of the nutritional intake viewing apparatus 10. For example, the model 60 retains all of the patient chart information concerning intake orders and administrations. The model 60 also retains information on the patient's weights. Additionally, as part of its initialization, the model 60 calculates the nutrient amounts, including the prospective nutrient amounts, for intake orders on the patient's chart.

The client tier 54 can include a controller module 62, a dialog 64, one or more user interface components 66, 68. The controller 62 can be a processor configured to obtain the model 60 from the NutriWeb service 58 on the server 52. The controller can be configured to create and obtain the user interface component dialog 64, e.g., dialog 48. The controller can also be configured to handle the main events from the dialog 64 and user interface components 66, 68, such as the user input 16 to change the MAW diagram 20 on the display 14 or graphs 24 displayed on the diagram 20. The dialog 64 is a display component that may use standard user interface components pre-existing on a workstation 12 and specialized user interface components for the MAW diagram 20 and the weight trend graph 32, such as a the web UI component 68 and weight graph UI component 66. In some embodiments, other specialized user interface components may be included in the client tier 54. The user interface components exist on the client 54. In particular embodiments, different dialogs 64 may be used to display the MAW diagrams 20 and other elements, such as tablets and smart phones. In particular embodiments, the dialog 64 may be replaced by a computer, a smart phone device, a PDA, e-glasses, a tablet, or the like.

FIG. 11 illustrates one method flow chart or means of monitoring the nutritional intake of patients by displaying one or more of the MAW diagrams 20 on a display of the nutritional intake viewing apparatus 10. In a step S100, patient input information is received on the workstation 12. This can involve accessing patient input information from the database or memory 26. For example, a clinician using the apparatus 10 can access a clinical information system and open the patient's electronic record. In particular embodiments, this step may occur on the workstation 12, or on at least one of a computer, a smart phone device, a PDA, e-glasses, and a tablet. The apparatus 10 identifies, collects, and calculates relevant information, such as nutrient intake orders, administrations, and configuration information, in order to generate the model 60. In a step S102, the collected information is initialized on the display device 14, including generating one or more MAW diagrams 20 as elements on the display 14. The one or more processors 18 of the apparatus 10 are configured to control the layout of the display 14. In a step S104, the apparatus 10 graphs calculated nutrient amounts onto a corresponding one of the axes 22 of the one or more MAW diagrams 20. In a step S106, the one or more processors 18 of the apparatus determines whether there is new nutrient input information to be displayed on the display 14, such as new or revised intake orders or additional charted administrations. If there is, the display 14 is updated. Then, in a step S108, the one or more processors 18 of the apparatus determine whether there has been input from the input device 16 or the web UI 68, etc. For example, input from the input device 16 can include changing time period toggle 38, changing web toggle 42, changing the weight graph time period 34, hovering over the weight graph 32, changing the weight menu 46 corresponding to a time period toggle 38, and clicking on an axis 22 of one of the displayed MAW diagrams 20. If the apparatus 10 has received an input from the input device 16, then the preceding steps are repeated from either S102 or S 104, depending on the input.

The invention has been described with reference to the preferred embodiments. Obviously, modifications and alterations will occur to others upon reading and understanding the proceeding detailed description. It is intended that the invention be construed as including all such modifications and alterations insofar as they come within the scope of the appended claims or the equivalents thereof.

1. A nutritional intake viewing apparatus for monitoring patient nutrient intake, the apparatus comprising:
a workstation including a display device configured to display nutritional and physiological information, and an input configured to receive one or more inputs;
one or more computer processors connected to the workstation, the one or more computer processors being configured to:
receive nutrient input information;
generate one or more multi-axis web diagrams on the display, each axis corresponding to one of a plurality of nutrients;
graph calculated nutrient amounts onto a corresponding one of the axes; and
update the display based on inputs or additional nutrient input information received at the workstation.

2. The apparatus according to claim 1, further including at least one memory configured to store at least one of the calculated nutrient amounts for a plurality of prior days, wherein the one or more processors are further configured to graph prospective and retrospective calculated nutrient amounts onto the one or more multi-axis web diagrams.

3. The apparatus according to claim 1, wherein the one or more multi-axis web diagrams include:
a plurality of axes diverging from a single common point of intersection;
the calculated nutrient amounts displayed on the axes of the multi-axis web diagram; and
connecting lines that connect the calculated nutrient amounts on the axes to form a polygon graphing of the calculated nutrient amounts.

4. The apparatus according to claim 1, wherein the one or more processors are configured to generate one or more multi-axis web diagrams on the display that further comprise:
at least one inner polygon; and
at least one outer polygon;
wherein the inner polygon borders a region which defines nutrient intake values that are within a lower target range, and the outer polygon borders a region which defines nutrient intake values that are within an upper target range.

5. The apparatus according to claim 4, wherein the one or more processors are configured to look-up and receive a patient's weight, to normalize input information based on the patient's weight, and to display the normalized input information.

6. The apparatus according to claim 5, the patient's weight may comprise a plurality of weights, and the one or more processors are further configured to normalize input information based on the plurality of weights, and to update the display based on the normalized input information.

7. The apparatus according to claim 1, wherein the one or more multi-axis web diagrams includes one or more of a general nutritional web diagram, an electrolytes web diagram, and a micronutrients web diagram.

8. The apparatus according to claim 7, wherein the one or more computer processors are further configured to control the display device to simultaneously display one or more graphs of the calculated nutrient amounts on a single multi-axis web diagram.

9. The apparatus according to claim 7, wherein the one or more processors are configured to control the display device to display a plurality of graphs of calculated nutrient amounts that have not yet been administered.

10. The apparatus according to claim 7, wherein:
the general nutritional web diagram includes nutritional and physiological information for one or more of fluids, carbohydrates, fats, protein, and calories;
the electrolytes web diagram includes nutritional and physiological information for one or more of sodium, potassium, calcium, chloride, magnesium, and phosphate; and
a micronutrients web diagram includes nutritional and physiological information for one or more of manganese, iron, zinc, selenium, iodine, and copper.

11. A multi-axis web diagram for displaying a patient's nutritional intake information on a display device, comprising:
a plurality of axes, each axis corresponding to one of a plurality of calculated nutrient amounts, wherein the calculated nutrient amounts are graphed onto a corresponding one of the axes.

12. The multi-axis web diagram according to claim 11, wherein the multi-axis web diagram includes:
the plurality of axes diverging from a single common point of intersection;
the calculated nutrient amounts displayed on the axes of the multi-axis web diagram; and
connecting lines that connect the calculated nutrient amounts on the axes to form a polygon graphing the calculated nutrient amounts.

13. The multi-axis web diagram according to claim 12, wherein the multi-axis web diagram further includes:
at least one inner polygon; and
at least one outer polygon;
wherein the inner polygon and the outer polygon define a region of target nutrient intake values.

14. The multi-axis web diagram according to claim 11, wherein the multi-axis web diagram includes one or more of a general nutritional web diagram, an electrolytes web diagram, and a micronutrients web diagram.

15. The multi-axis web diagram according to claim 11, wherein the web diagram includes at least one of:
a general nutritional web diagram including nutritional and physiological information for one or more of fluids, carbohydrates, fats, protein, and calories;
an electrolytes web diagram including nutritional and physiological information for one or more of sodium, potassium, calcium, chloride, magnesium, and phosphate; and
a micronutrients web diagram including nutritional and physiological information for one or more of manganese, iron, zinc, selenium, iodine, and copper.

16. A processor configured to generate the multi-axis web diagram for display on a display device.

17. A method of monitoring nutritional intake of a patient by using a nutritional intake viewing apparatus, the method comprising:
receiving nutrient input information at a workstation;
with one or more processors, generating one or more multi-axis web diagrams on a display, each axis corresponding to one of a plurality of nutrients;
with the one or more processors, graphing calculated nutrient amounts onto a corresponding one of the axes; and
updating the display based on input received or additional nutrient input information received at the workstation.

18. The method according to claim 17, wherein each multi-axis web diagram includes:
a plurality of axes diverging from a single common point of intersection;
the calculated nutrient amounts displayed on the axes of the multi-axis web diagram; and
connecting lines that connect the calculated nutrient amounts on the axes to form a polygon graphing the calculated nutrient amounts.

19. The method according to claim 18, wherein each multi-axis web diagram further includes:
at least one inner polygon; and
at least one outer polygon;
wherein the inner polygon and the outer polygon define a region of target nutrient intake values.

20. The method according to claim 18, wherein the multi-axis web diagram includes one or more of:
a general nutritional web diagram including nutritional and physiological information for one or more of fluids, carbohydrates, fats, protein, and calories;
an electrolytes web diagram including nutritional and physiological information for one or more of sodium, potassium, calcium, chloride, magnesium, and phosphate; and
a micronutrients web diagram including nutritional and physiological information for one or more of manganese, iron, zinc, selenium, iodine, and copper.

21. The method according to claim 18, wherein the method further comprises:
storing the nutrient input information; and
storing the additional nutrient input information;
wherein the updating of the display is performed prior to storing the additional nutrient input information.

22. A non-transitory computer readable medium carrying software for controlling one or more processors to perform the method according to claim 17.
